(19) United States
(12) Patent Application Publication
(10) Pub. No.: US 2011/0274790 A1
(43) Pub. Date: Nov. 10, 2011

(54) NOURISHING OIL COMPOSITION FOR INFANTS AND YOUNG CHILDREN

(75) Inventors: Jacob Laskow, Tel-Aviv (IL); Danny Dizer, Rishon le Zon (IL)

(73) Assignee: Shemen Industries, Ltd., Haifa (IL)

(21) Appl. No.: 12/597,949

(22) PCT Filed: Apr. 29, 2007
(86) PCT No.: PCT/IL2007/000522

§ 371 Date: Jul. 28, 2011

(51) Int. Cl. A23L 1/29; A23L 1/221; A23L 1/303; A23D 9/00; A23D 7/00

(52) U.S. Cl. 426/73; 426/601

(57) ABSTRACT

A nourishing fluid oil composition for young children and babies to be consumed during the transition period between breast feeding or bottle feeding and a fully varied diet comprising 35% or more oleic acid, less than 10% fatty acid C 16:0 at positions sn1 or sn3, and 9% or more omega 3, further comprising DHA and antioxidants and optionally comprising palmitic acid sn 2, wherein the ratio of omega 3 fatty acid to omega 6 fatty acid is between 1:2 to 1:4. To be used as a condiment in salads or for cooking, baking and light frying.

### TECHNICAL FIELD

The invention pertains to the field of infant and baby nutrition.

### BACKGROUND OF THE INVENTION

In recent years many kinds of nutrient compositions have been developed with a view to enhancing the supply of necessary fatty acids and their precursors to preterm as well as full term infants.

It is the objective of the prior art nutrient compositions is to imitate the fatty acid profile of human milk while using fats derived from diverse vegetal sources, having different fatty acid profiles.

Thus in U.S. Pat. No. 5,000,975 to Tomarelli a composition is disclosed that combines a lauric acid oil, an oleic acid oil and a linoleic acid oil with a randomized palmitic acid oil.

Fatty acids, especially long chain polyunsaturated fatty acids (PUFA) were found to be of crucial importance in the development of the nervous system, the brain and the vision. They are therefore considered an all important factor in the early nutrition of babies and infants. It has been shown that about 50% of the energy sources in infant food is derived from saturated fatty acids of C 16:0 at position sn 2 and oleic acid—C18:1. DHA, that is the most abundant long chain PUFA in the brain and retina, is thought to be essential for the proper brain and vision development of infants. These components are included in most prior art compositions.

The preparations of the prior art have several disadvantages:

Vegetable oil, applied as an energy source and source of PUFAs in milk replacements, differs from human milk in several characteristics, inter alia in the presence of 85% of Palmitic acid at position 1 and 3, whereas human milk contains 35% oleic acid and the palmitic acid that consists 25% of human milk fat content is always attached at position 2. The presence of Palmitic acid at positions one or three results in saponification in the intestines, causing digestion problems. Absorption in the intestines is also significantly higher when the C 16:0 fatty acids are at position 2 as in human milk. Vegetable oil milk replacements are therefore apt to cause constipation and extradition in babies and infants. Low absorption also results in calcium deficiency and reduced energy supply (Lucas 1997).

Many prior art compositions contain palm kernel oil and/or coconut oil mainly composed of saturated medium chain free fatty acids shorter than 16:0 as a source of energy, having the advantage that they do not undergo saponification with calcium ions. These oils are in fact solid fats at room temperature conditions. It is therefore impractical to use the compositions of the prior art as an edible oil for salads etc. In fact, the composition would at least have two phases and would need to be heated before it could be poured onto a salad.

Additionally, Tryglicerids undergo hydrolysis in the presence of water and catalysts such as enzymes, both found in salad vegetables and other foods. As a result of hydrolysis free fatty acids are released, with a direct bearing on the flavour of the oil. Where the oil contains only palmitic,oleic, linoleic and stearic acids hydrolysis rancidity yields fatty acid products with a taste and smell that are not very different from those of original oil. However lauric oils such as palm kernel oil and coconut oils release capric and lauric acids, whose flavour threshold that is much lower than that of palmitic acid and stearic acids, the flavour threshold being the minimum concentration in which a pure compound can be perceived by 50% of panel tasters. Short chain fatty acids—acetic acid to capric acid—have threshold values in the range 1 to 10 P.P.M whereas lauric and myrisitic acids have values of 50 P.P.M. For this reason, using compositions containing lauric oils as an edible oil for a young child wouldn't be practical, especially considering the fact that grownup members of the family may also participate in the same meal.

It is also known from the prior art that Lauric acid may cause mucous membrane irritation and that this fatty acid produces froth when warmed to 100 degrees together with other fatty acids. It is known from the prior art that no more than 10% of palmitic acid in positions other than 2 should be used in milk replacement formulas.

Other prior art compositions such as those described in JP4287637 are chemically and enzymatically processed to alter the natural composition of the vegetable oil and enable the imitation of human milk properties.

The vegetable oil fat compositions disclosed in the above mentioned U.S. Pat. No. 5,000,975 also contain a randomized palmitic oil, characterized by having a larger percentage of palmitic acid at position 2 than that found in natural palmitic oil, in order to simulate the larger concentration of palmitic acid at position two that is characteristic of human milk. As described in U.S. Pat. No. 5,000,975, interesterification, also called randomization (since it alters the non-random distribution of nature), may be accomplished by heating the fat or oil for a short period of time, usually with a catalyst such as sodium methylate. Though it is well known from the prior art that raising the percentage of palmitic acid at position two facilitates absorption of this important fatty acid energy source, recent tendencies in research and consumer preference indicate strongly against the consumption of processed food and it is considered increasingly preferable to use natural components and compositions, especially where young children are concerned.

The prior art proposes various milk replacements to be applied where the mother is unable or unwilling to breast feed the infant. However none of the prior art documents proposes a nourishing edible fluid oil composition for seasoning, baking and light frying to be consumed as an integral part of the infant's gradually diversifying diet during the transition period from bottle or breast feeding.

It is therefore desirable to develop a nourishing edible oil composition for young children and babies to be consumed during the transition period from a full milk diet to diversified grownup diet.

It is also desirable to develop a nourishing edible oil composition for young children and babies that is fluid at room temperature.

It is desirable to overcome the drawbacks of the prior art by controlling the proportion of different fatty acids through determining the percentage of oil components rather than using artificial processing such as trans esterification by chemical means.

It is further desirable to develop a nourishing edible oil composition for young children and babies that contains the fatty acids necessary for the development of the nervous system, of the brain and of visionary skills, while having a reduced content of palmitic and lamic acid, compliant with the fact that at this transition phase the young child has access to increasingly diversified foods as source of energy.

It is desirable to introduce in these compositions an increased content of oleic acid that has the advantage of being a monosaturated fatty acid.

It is further desirable to develop a nourishing edible oil composition for young children and babies with a pleasant taste such that it may be used for the cooking and conditioning of food during the transition period from a full milk diet to a diversified grownup diet while it may also be consumed by grownups.

### SUMMARY OF THE INVENTION

A nourishing fluid oil composition for young children and babies to be consumed during the transition period between breast feeding or bottle feeding and a fully varied diet comprising 35% or more oleic acid, less than 10% fatty acid C16:0 at positions sn1 or sn3, and 9% or more omega 3, further comprising DHA and antioxidants and optionally comprising palmitic acid sn 2, wherein the ratio of omega 3 fatty acid to omega 6 fatty acid is between 1:2 to 1:4.

### DETAILED DESCRIPTION OF THE INVENTION

The invention will be described herein below in detail and in accordance with examples that are to be regarded as non limiting preferred embodiments. It will be understood that many other ways and means of performing the inventive method are envisaged without exceeding the scope of the invention as defined and claimed in the claims.

In accordance with one aspect of the invention, the invention proposes a nourishing oil composition that is fluid at room temperature, to be consumed during the transition period between breast or bottle feeding and fully diversified grownup nutrition. The oil composition of the invention is intended for use as a condiment in salads and other food products as well as an oil for baking and light frying.

In accordance with a second aspect of the invention, the inventive composition is a nourishing fluid oil composition for young children and babies to be consumed during the transition period between breast feeding or bottle feeding and a fully varied diet comprising 35% or more of oleic acid, less than 10% fatty acid C16:0 at positions sn1 or sn3 and 9% or more omega 3, and further comprising DHA, preferably of algae oil, and antioxidants such as tocopherols, Rosmarinic acid or Carnosic acid and optionally comprising palmitic acid sn 2, and wherein the ratio of omega 3 fatty acid to omega 6 fatty acid is between 1:2 (6-12month) to 1:3-1:4 (8-24 months).

The proposed composition contains different PUFA's and Omega 3 fatty acids necessary for the development of the nervous system, of the brain and of visionary skills such as DHA from algae and ALA from Canola oil or omega 3 extracted from Salvia or linseed, by cold press together with oleic acid as an energy source to which various vitamins and antioxidants are added to further boost the general development and health of the child. Salvia oil naturally contains polyphenols with an antioxidant effect that protect the long chain polyunsaturated fatty acids from oxidation.

It is well known from the prior art that fatty acids of the Omega 3 group are relatively sensitive to oxidation. The inclusion of antioxidants such as tocopherols, rosmarinic acid and carnosic acid is therefore important for the prevention of oxidation, thus prolonging the shelf lifetime of the inventive composition.

It will be understood by those versed in the art that while it is important to include in the proposed composition components that are important for the early development of the child such as one or more sources of energy, one or more PUFAs, DHA, ALA, Omega 3, vitamins, antioxidants etc., it is no more necessary at the partial weaning or post weaning stages to closely imitate the composition of human milk.

It will be further understood that in the early months after weaning enzyme activity of DHA production from alpha linoleic acid (ALA) is still quite low. For this reason DHA is included in the inventive composition in addition to ALA.

Many nutrient compositions of the prior art intended for the early age are prepared with an objective to imitate the fatty acid profile of human milk while using fats derived from diverse vegetal sources, having fatty acid profiles that differ considerably from that of human milk. Thus human milk contains about 25% palmitic acid at position 2 and about 35% oleic acid whereas in vegetable sources 85% of the palmitic acid is at position 1 or 3.

Many of the prior art compositions contain palm kern oil and/or coconut oil as a vegetable source of energy and PUFAs. These oils are in fact solid fats at room temperature conditions. It is therefore impractical to use the compositions of the prior art as edible oils for salads etc. In fact, the composition would at least have two phases and would need to be heated before it could be poured onto a salad.

Thus it is an important advantage of the inventive composition that it contains oils that are fluid at room temperature and may be poured as normal household oil.

It will be obvious to those versed in the art that a composition containing a high percentage of palm kern oil or coconut oil or both could not be used as an oil to be added to salads due to the fact that triglycerides tend to undergo hydrolysis in the presence of water and catalysts such as enzymes, both found in salad vegetables and other foods. As a result of hydrolysis free fatty acids are released, with a direct bearing on the flavour of the oil. Where the oil contains only palmitic,oleic, linoleic and stearic acids hydrolysis rancidity yields fatty acid products with a taste and smell that are not very different from those of original oil. However lauric oils such as palm kernel oil and coconut oils release capric and lauric acids, whose flavour threshold that is much lower than that of palmitic acid and stearic acids, the flavour threshold being the minimum concentration in which a pure compound can be perceived by 50% of panel tasters. Short chain fatty acids—acetic acid to capric acid—have threshold values in the range 1 to 10 P.P.M whereas lauric and myrisitic acids have values of 50 P.P.M. For this reason, using compositions containing lauric oils as an edible oil for a young child wouldn't be practical, especially considering the fact that grownup members of the family may also participate in the same meal.

The inventive composition proposes a solution for the above problem by having a reduced content of palmitic and lauric acid, compliant with the fact that at this transition phase the young child has access to increasingly diversified foods as source of energy. It is desirable to introduce in the compositions according to the invention an increased content of oleic acid that has the advantage of being a monosaturated fatty acid.

It is known from the prior art that both palm kern oil and coconut oil contain lauric acid as a large percentage of the fatty acid molecules attached at positions one two or three, thus differing from human milk that is rich in palmitic acid at position 2.

It is also well known that absorption in the intestines is significantly higher when the palmitic acid C16:0 is at position 2 as in human milk. Vegetable oil milk replacements are therefore apt to cause constipation and extradition in babies and infants. The low percentage of palmitic and lauric acid and their replacement by the mono saturated fatty acid oleic acid as energy source in the inventive composition helps to overcome these problems by increasing absorption as well as preventing mucous membrane irritation caused by Lauric acid.

It is important to note that consumption of the inventive composition by women is advantageous as the saponification process characteristic of saturated PUFA's above 14C such as Palmitic acid absorbs the Calcium ions that are vital for this section of the population.

The low percentage of Lauric acid in the composition also prevents the effect of froth produced when this fatty acid is warmed to 100 degrees together with other fatty acids, making it possible to use the inventive oil for light frying.

Several research findings have shown that excessive amounts of omega-6 polyunsaturated fatty acids (PUFA) and a very high omega-6/omega-3 ratio, as is found in today's Western diets, promote the pathogenesis of many diseases, including cardiovascular disease, cancer, and inflammatory and autoimmune diseases, whereas increased levels of omega-3 PUFA (a low omega-6/omega-3 ratio) exert suppressive effects. (Simopoulos AP PubMed October 2002).

It is therefore one of the advantages of the nutrient oil of the present invention that a ratio of 1:2 to 1:4 of omega 3:omega 6 is observed, that is a considerable improvement compared to the ratio of 1:24 in western diet.

Many of the prior art compositions are chemically processed to alter the natural composition of the vegetable oil and enable the imitation of human milk properties.

Recent tendencies in research and consumer preference indicate strongly against the consumption of processed food and it is considered increasingly preferable to use natural components and compositions, especially where young children are concerned.

It is yet another advantage of the oil composition of the present invention that only natural food products are used and components are not subjected to artificial processing such as chemical randomization to increase the percentage of palmitic acid at position 2. In accordance with the inventive composition the percentage of position 2 palmitic acid is controlled mainly through the selection of the components of the oil composition.

The versatility, availability and affordable price of components such as sunflower oil or soy oil that are the principal sources of omega 6 fatty acids is well known.

The inventive oil composition thus has the further advantage of being cost saving due to the ratio of 1:2 to 1:4 between omega 3 and omega 6 oils.

Finally the inventive oil composition has the advantage that food prepared with this oil composition has a more pleasant taste than the prior art due to the improved organoleptic qualities of sunflower oil.

The following are examples of oil compositions in accordance with the invention, not intended to limit the scope of the invention.

### Example I

A nutrient oil composition recommended for 6-12 months

The following table describes the components proposed for an example of a bottled oil suitable for seasoning, cooking, baking and very light frying in accordance with the invention that is recommended for 6-12 months wherein the contribution of each ingredient to the final percentage of a nutrient is shown (percentage by volume, except where otherwise indicated):

| | | | Saturated | Palmitic | | |
|---|---|---|---|---|---|---|
| | | Oleic | fatty acid | acid | | |
| component | % | acid | sn 1,3 | sn-2 | DHA | ALA |
| Canola oil | 76.5% | 53.63% | 3.4% | 0.6% | | 7.5% |
| Oil (--45% | 20% | 8.1% | 2.5% | 2% | | 0.3% |
| sn-2) | | | | | | |
| Algae oil | 1% | | 0.2% | | 0.46% | 0.22% |
| ALA oil* | 2% | 0.5% | 0.11% | 0.02% | | 1.1% |
| Carnosic | 0.1% | | | | | |
| acid** | | | | | | |
| Vitamins | 20% of | | | | | |
| A C D E*** | RDI in | | | | | |
| | 2 tsp | | | | | |
| | of oil | | | | | |
| TOTAL | 100% | 62.23% | 6.2% | 2.6% | 0.46% | 9.12% |

ALA oil of Salvia oil or Linoleic oil source free of Cyanidic acid and free of traces of allergenics
**Natural source antioxidant extracted from Rosemary
***20% of RDI in two spoonfuls of oil

It will be understood that while use of the nourishing oil composition of example I is more recommended for the early age of 6-12 months when an increased supply of palmitic acid at position sn-2 is necessary, this composition may be applied for a more advanced age and the indication of 6-12 months is not intended to be limiting to the invention.

### Example II

A nutrient oil composition recommended for 8-24 months

The following table describes the components proposed for an example of a bottled oil suitable for seasoning, cooking, baking and very baking and light frying in accordance with the invention that is recommended for 8-24 months, wherein the contribution of each component to the final percentage of a nutrient is shown (percentage by volume, except where otherwise indicated):

| | | | Saturated | Palmitic | | |
|---|---|---|---|---|---|---|
| | | | fatty acid | acid | | |
| component | % | Oleic acid | sn 1,3 | sn-2 | DHA | ALA |
| Canola oil | 86.5% | 53.63% | 3.4% | 0.7% | | 8.5% |
| Sunflower | 10% | 1.9% | 0.6% | 0.1% | | 0.1% |
| oil | | | | | | |
| Algae oil | 1% | | 0.2% | | 0.46% | |
| ALA oil* | 2% | 0.5% | 0.11% | 0.002% | | 1.1% |
| Carnosic | 0.1% | | | | | |
| acid** | | | | | | |
| Vitamins | 20% of | | | | | |
| A C D E*** | RDI in | | | | | |
| | 2 tsp | | | | | |
| | of oil | | | | | |
| TOTAL | 100% | 56% | 4.31% | 0.8% | 0.46% | 9.7% |

*ALA oil of Salvia oil or Linoleic oil source free of Cyanidic acid and free of traces of allergenics
**Natural source antioxidant extracted from Rosemary
***20% of RDI in two spoonfuls of oil

It will be noted that the position sn-2 palmitic acid content in example II is lower than in example I and to prevent an undesirably high content of palmitic acid at positions sn 1, 3 an added amount of oleic acid is included.

It will be understood by those versed in the art that while this composition is recommended as an edible oil for consumption between 8 months to 2 years, there is no precise limitation to the actual start of use that also depends on the ambit of variation in the infant's diet. It will be further understood that the recommended period is not to be regarded as restrictive to the invention and actual use of the composition of example 2 may continue beyond the age of 24 months.

1. A nourishing fluid oil composition for young children and babies to be consumed during the transition period between breast feeding or bottle feeding and a fully varied diet comprising 35% or more oleic acid, less than 10% fatty acid C16:0 at positions sn1 or sn3, and 9% or more omega 3, further comprising DHA and antioxidants and optionally comprising palmitic acid sn 2, wherein the ratio of omega 3 fatty acid to omega 6 fatty acid is between 1:2 to 1:4.

2. A nourishing fluid oil composition for young children and babies according to claim 1 wherein the said antioxidants are of vegetable source.

3. A nourishing fluid oil composition for young children and babies according to claim 1 wherein the said antioxidants are selected from the group of tocopherols.

4. A nourishing fluid oil composition for young children and babies according to claim 1 wherein the said antioxidants are Rosmarinic acid or Carnosic acid.

5. A nourishing fluid oil composition for young children and babies according to claim 1 wherein the said DHA is of vegetable source.

6. A nourishing fluid oil composition for young children and babies according to claim 1 wherein the said vegetable source is algae oil.

7. A nourishing fluid oil composition for young children and babies according to claim 1 wherein the said DHA is of fish oil.

8. A nourishing fluid oil composition for young children and babies according to claim 1 to be used as a condiment in salads and other foods.

9. A nourishing fluid oil composition for young children and babies according to claim 1 to be used for baking.

10. A nourishing fluid oil composition for young children and babies according to claim 1 to be used for light frying.

11. A nourishing fluid oil composition according to claim 1, adapted for use of infants of ages between 6-12 months, wherein the ratio of omega 3 fatty acid to omega 6 fatty acid is 1:2.

12. A nourishing fluid oil composition that according to claim 1, adapted for use of infants and young children of ages between 8-24 months, wherein the ratio of omega 3 fatty acid to omega 6 fatty acid is between 1:3-1:4.

13. A nourishing fluid oil composition according to claim 1, adapted for use of infants of ages between 6-12 months, comprising up to 63% oleic acid, saturated fatty acid sn 1,3 6-6.5%; palmitic acid sn2 2.3-2.6%; DHA 0.42-0.47%; ALA 9.12% ̂ carnosic acid 0.1-0.2%; Vitamins A5C5E 20% of RDI in 2 spoonfuls.

14. A nourishing fluid oil composition according to claim 1, adapted for use of infants and young children of ages between 8-24 months, comprising oleic acid 55-58%; saturated fatty acid sn 1,3 4-4.5%; palmitic acid sn2 0.5-0.9% DHA 0.42-0.2-0.6%; ALA 8.00 -11.00%;
carnosic acid 0.1-0.2%; Vitamins A5C5E 20% of RDI in 2 spoonfuls.
